(19) United States
(12) Patent Application Publication
(10) Pub. No.: US 2023/0021175 A1
(43) Pub. Date: Jan. 19, 2023

(54) HYDRAULIC BRAKE DEVICE FOR A MOTOR VEHICLE BRAKE SYSTEM HAVING AN IMPROVED CONTAINER CONNECTION

(71) Applicant: Continental Automotive Technologies GmbH, Hannover (DE)

(72) Inventors: Mike Hirsemann, Darmstadt (DE); Rüdiger Briesewitz, Brüchköbel (DE); Joseph Dolmaya, Langen (DE); Stephan Schlicht, Nauheim (DE); Dieter Dinkel, Schwalbach (DE)

(73) Assignee: Continental Automotive Technologies GmbH, Hannover (DE)

(21) Appl. No.: 17/757,632

(22) PCT Filed: Dec. 7, 2020
(86) PCT No.: PCT/EP2020/084794

§ 371 Date: Jun. 17, 2022

(30) Foreign Application Priority Data
Dec. 17, 2019 (DE) 10 2019 219 869.4

(51) Int. Cl. B60T 11/26; B60T 11/22; B60T 7/04

(52) U.S. Cl. CPC B60T 11/26; B60T 11/22; B60T 7/04

(57) ABSTRACT

A brake device for a hydraulic motor vehicle brake system comprises at least one brake device housing which has a front side oriented substantially in the direction of travel and a rear side oriented counter to the direction of travel after being mounted in the vehicle. At least one pressure medium container is arranged on the brake device housing and has a container housing. The pressure medium container has at least one first connection piece for supplying the brake device with a hydraulic pressure medium, which is oriented substantially parallel or at an acute angle to the direction of travel and plugged in a receiving seat formed in the brake device housing.

### CROSS-REFERENCE TO RELATED APPLICATION

This U.S. patent application claims the benefit of PCT patent application No. PCT/EP2020/084794, filed Dec. 7, 2020, which claims the benefit of German patent application No. 10 2019 219 869.4, filed Dec. 17, 2019, both of which are hereby incorporated by reference.

### TECHNICAL FIELD

The invention relates to a brake device for a hydraulic motor vehicle brake system.

### BACKGROUND

Hydraulic brake devices for motor vehicles are widely used. In these systems, with the aid of pistons acting on a hydraulic pressure medium, for example a brake fluid, brake pressure is generated. Furthermore, such brake devices can contain electromechanical drives, force boosting units and diverse valve arrangements. A brake device housing which contains all the abovementioned components is usually referred to as a hydraulic block.

The required hydraulic pressure medium is provided to the brake device from a pressure medium container via hydraulic connections. It is known practice to arrange the pressure medium container above the brake device on the brake device housing. For connecting the pressure medium container to the brake device, use is made of tubular connection pieces which are plugged in a vertical direction into corresponding receptacles in the brake device housing.

Efforts are made in vehicles to use the available space as effectively as possible and in the process to maximize the share of the passenger compartment at the expense of the engine compartment. Moreover, modern vehicles increasingly have particularly flat windshields which, for example for stylistic or aerodynamic reasons, are very greatly inclined. In order nevertheless to ensure sufficient headroom for the driver, such windshields extend a long way to the front. This often results in the formation of a pronounced overhang in a region directly above the site at which a brake device is mounted.

Because a pressure medium container needs to be easily reachable to be filled, this has the result that pressure medium containers extend a long way forward in the direction of travel starting from the position of the connection piece, in order to overcome the overhang. Furthermore, the tight space under the overhang has the result that container housings need to be constructed at the same time in a shallow and wide manner in order to be able to provide the required volume. In order to achieve the required stability and rigidity, they are provided with various internal struts and great wall thicknesses, making production more complex and the price higher.

The hydraulic pressure medium is often combustible, and so there are frequently requirements that, in the event of a crash, no hydraulic pressure medium can pass uncontrollably into the engine compartment where it could possibly come into contact with hot engine parts and ignite. In the event of a crash, very high acceleration forces act on the pressure medium container, and these acceleration forces could tear it out of its seat in the brake device housing. In order to avoid a loss of pressure medium in such a case, it is known practice to provide separate shut-off valves in the connection pieces, said shut-off valves blocking the hydraulic connection through the connection pieces away from the receiving seats. In the case of serious crash situations, in particular a frontal impact at high speed, such high acceleration forces that act on the pressure medium container may arise that the connection pieces are torn from the container housing or the container housing collapses entirely.

A container housing that extends a long way forward in the direction of travel increases this risk because the acceleration forces acting thereon are increased even further by lever effects.

It is therefore an object to propose an improved brake device that has a pressure medium container and avoids the abovementioned drawbacks while at the same time affording increased crash safety.

### BRIEF SUMMARY

A pressure medium container has at least one first connection piece for supplying the brake device with a hydraulic pressure medium, which is oriented substantially parallel or at an acute angle to the direction of travel and plugged in a receiving seat formed in the brake device housing. As a result, the risk of a connection piece being torn out, for example in the event of a frontal impact, is eliminated or at least significantly reduced.

According to a one development, the pressure medium container may be arranged substantially on the front side of the brake device housing and fastened thereto. In this way, the tight space above the brake device is avoided and, instead, a more accessible space directly in front of the brake device is used. The requirements for stability of the container housing can be lowered as a result, and the container housing can be produced with thinner walls. Accessibility for the filling plant is likewise improved.

The pressure medium container has at least two fastening tabs for fastening to the brake device housing, wherein the fastening tabs extend substantially in the direction of travel and are spaced apart from one another transversely to the direction of travel, wherein each fastening tab is connected to the container housing or is integrally formed on the container housing by a first end and has a fastening eye at another end. As a result, the pressure medium container can be held securely on the brake device housing even when it is mounted on the front side of the brake device and with a connection piece oriented in the direction of travel. The forces that arise during filling under pressure are likewise absorbed.

In order to fix the pressure medium container to the brake device housing psimply, securely, quickly and without screws, the pressure medium container may be to the brake device housing by a transverse bolt which is plugged through an aperture in the brake device housing and through the fastening eyes in the two fastening tabs and is fixed at least in an axial direction via a latching connection at at least one fastening eye.

Simple and efficient protection of the transverse bolt against loss can be realized when the latching connection is realized by a plurality of spring clips which are arranged around the fastening eye on at least one fastening tab and engage radially around a terminal thickening of the transverse bolt.

For increased crash safety, the fastening tab is in the form of a predetermined breaking point such that it breaks in two at at least one point under a defined breaking load, wherein the breaking load used for a structural design of the fastening tab is chosen to be higher than a tensile force acting on the fastening tab when the pressure medium container is filled under pressure and at the same time lower than a smallest possible force that is necessary for a loss of integrity of the container housing on account of acceleration forces acting on the container housing from the inside and/or outside. As a result, it is possible for the container housing to be detached from the brake device under controlled conditions and at defined loads before leaks arise in the container housing.

In order to shift the predetermined breaking point from the container housing to the fastening tab, the fastening tabs are offset in the direction of travel with respect to a center of gravity of the pressure medium container. As a result, the load on defined portions of the fastening tabs can be enhanced by lever and torque effects.

For reliable and uniform force absorption during a buffalo operation, in one embodiment, the pressure medium container may have at least one second connection piece, which is oriented parallel to the first connection piece and is spaced apart therefrom in a vertical direction, and the fastening tabs are arranged in the vertical direction in a region between the first and the second connection piece.

In another development, a hydraulically tight membrane is arranged in the container housing, said membrane bearing at least partially on an outer wall of the container housing, for example lining the latter more or less entirely. As a result, even if the container housing is damaged, uncontrolled escape of pressure medium can be prevented.

The developments may be employed in a brake device which is actuable via an electromotive drive unit and comprises an electronic control unit, wherein the drive unit and the control unit are fastened to the brake device housing on opposite sides.

In order to ensure emergency braking or braking in a fallback level away from regular brake operation, the brake device may be mechanically actuable by a driver via an actuating member which is arranged on the rear side of the brake device housing.

### BRIEF DESCRIPTION OF THE DRAWINGS

Further features and advantages of the invention will become apparent from the following description. In the appended drawings:

FIG. 1 shows a highly simplified depiction, not to scale, of an embodiment, mounted in a vehicle, of a brake device in a view transverse to the direction of travel;

FIG. 2 shows a highly simplified depiction, not to scale, of a brake device according to FIG. 1 in plan view;

FIG. 3 shows a detail view of the latching connection for the transverse bolt;

FIG. 4 shows a three-dimensional view of an embodiment of the brake device; and

FIG. 5 shows a three-dimensional view of a pressure medium container according to FIG. 4.

### DETAILED DESCRIPTION

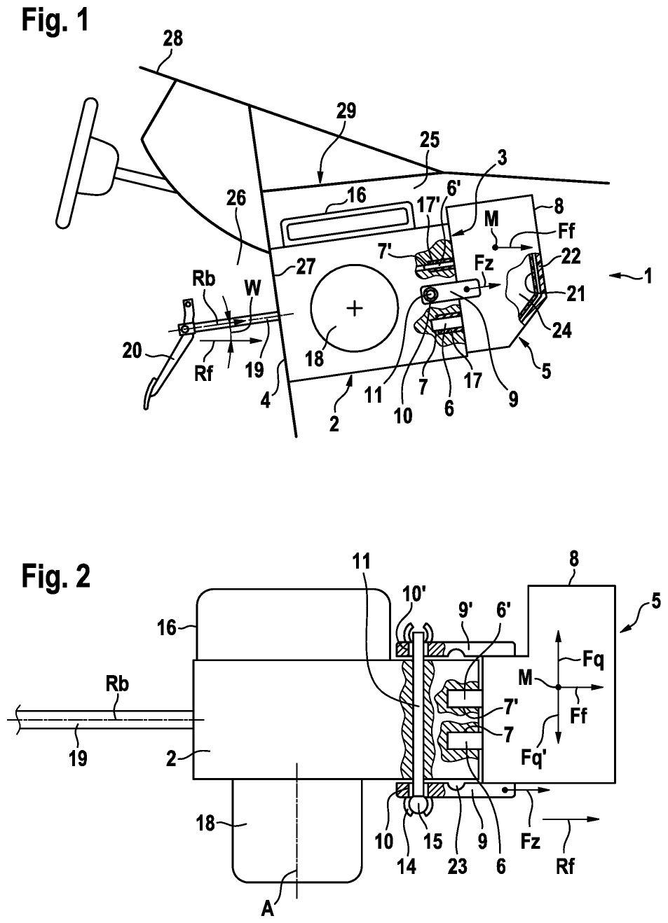

FIG. 1 shows a simplified view, not to scale, of an embodiment of a brake device 1. A bulkhead 27, as it is known, separates the engine compartment 25 from the passenger compartment 26 in a vehicle. The brake device 1 is mounted in the engine compartment 25 with a rear side 4 of its substantially cuboid brake device housing 2 on a bulkhead 27 of the vehicle. A bulkhead 27 is generally oriented orthogonally or at a slight angle to the direction of travel Rf in a vehicle. A front side 3, opposite and parallel to the rear side 4, of the brake device housing 2 thus likewise remains oriented orthogonal or at a slight angle to the direction of travel Rf after being mounted in the vehicle.

The brake device 1 is mechanically actuated by the driver by way of an actuating member 19 that is coupled to a pedal 20 and engages in the rear side 4 of the brake device housing 2. Depending on the manner in which the articulation of the actuating member 19 is embodied, the latter runs along or wobbles very slightly about the actuation direction Rb. The actuation direction Rb is thus oriented substantially axially parallel or at a very acute angle W to the direction of travel Rf, wherein the angle W usually lies in a range less than 10°.

Such a brake device housing 2 can, in practice, internally contain a plurality of hydraulic circuits and pressure generating and control components, these not being explicitly depicted here, and is often referred to as a hydraulic block.

In addition to mechanical actuation, the brake device 1 can be actuated via an electromotive drive unit 18, which drives for example a hydraulic pump (not shown explicitly here) inside the brake device housing 2. The brake device 1 can be controlled via an electronic control unit 16. The drive unit 18 and electronic control unit 16 are attached to two opposite sides of the brake device housing 2, and the drive axis A of the drive unit 18 is oriented transversely to the actuation direction Rb.

On account of the flat inclination angle of the windshield 28, there is a pronounced overhang 29 above the site at which the brake device 1 is mounted.

Mounted on the front side 3 of the brake device housing 2 is a pressure medium container 5. The pressure medium container 5 has a container housing 8 with one or more chambers 24, filled with the hydraulic pressure medium, formed therein. Formed on the container housing 8 are two mutually parallel connection pieces 6, 6′ that are spaced apart in a vertical direction. The connection pieces 6, 6′ serve to feed the hydraulic components (not shown explicitly here) within the brake device housing 2 with the pressure medium from the pressure medium container 5.

Analogously to the actuation direction Rb, the connection pieces 6, 6′ are oriented axially parallel or at a slightly acute angle W to the direction of travel Rf, plugged into corresponding receiving seats 7, 7′ in the front side 3 of the brake device housing 2 and sealed off therein by sealing elements 17, 17′. The pressure medium container 5 also has shut-off valves (not explicitly shown here) which forcibly shut off the connecting ducts within the connection pieces 6, 6′ when the connection pieces 6, 6′ are located away from the receiving seats 7, 7′.

In the vertical direction, in a region between the two connection pieces 6 and 6′, two fastening tabs 9, 9′ are attached to the container housing 8 at a defined spacing transversely to the direction of travel Rf, said fastening tabs 9, 9′ serving to secure the pressure medium container to the brake device housing 2.

A pressure medium container 5 filled with pressure medium has a defined center of gravity M in the operational state. The fastening tabs 9, 9′ are designed such that their attachment points to the container housing 8 are arranged at the distance from this center of gravity in the direction of travel Rf.

In the shown embodiment of the container housing 8, the latter is lined with a membrane 21 which bears on the outer wall 22 of the container housing 8. The membrane 21 serves to prevent the escape of pressure medium if the outer wall 22 is damaged for example by cracks.

FIG. 2 shows the embodiment of the brake device according to FIG. 1 in a plan view and with several cutouts in order to clarify the mounting and securing of the pressure medium container 5 on the brake device housing 2.

The pressure medium container 5 is made of plastic, for example by way of an injection-molding process, and can be produced in one piece or welded or adhesively bonded from several parts. In order to make optimal use of the available space, the container housing 8 is approximately L-shaped. The center of gravity M is, as a result, offset in the transverse direction with respect to the actuation axis Rb.

The two fastening tabs 9, 9′ extending in the direction of travel Rf engage around both sides of the brake device housing 2. Each fastening tab 9, 9′ is connected to the container housing 8 by its container-side end, for example integrally formed thereon, adhesively bonded thereto, welded thereto or screwed thereto. At its end facing the brake device housing 2, each fastening tab 9, 9′ has a fastening eye 10, 10′. A plurality of spring clips 14 are integrally formed around the fastening eye 10.

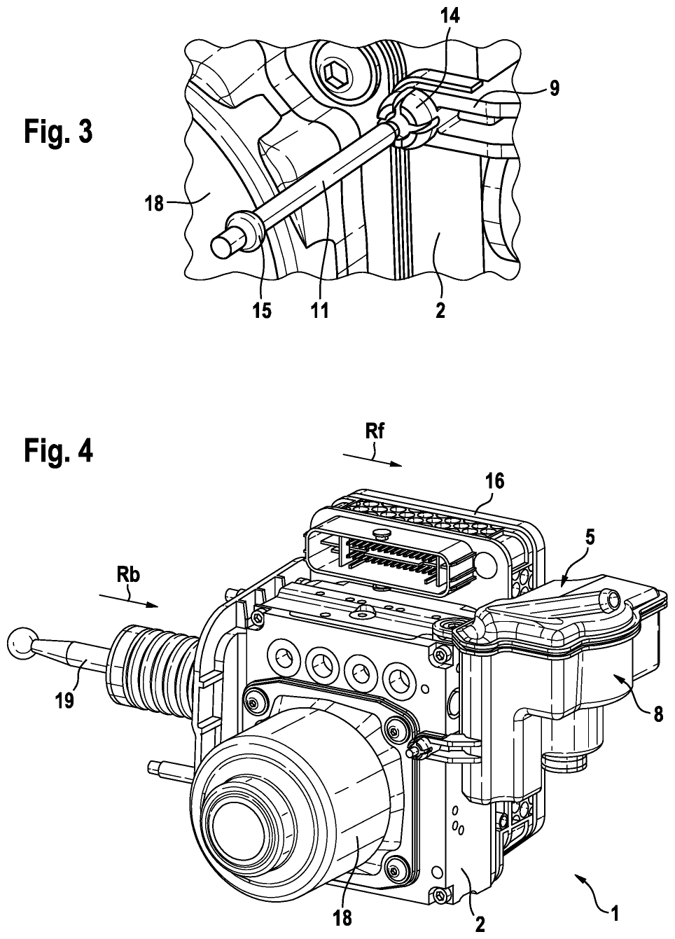

A transverse bolt 11 serves to secure the pressure medium container 5 to the brake device housing 2. The transverse bolt 11 is substantially in the form of a pin and has a thickening 15 at one end. When the pressure medium container 5 is mounted, the transverse bolt 11 is plugged through a through-bore in the brake device housing 2 and through the two fastening eyes 10. The thickening 15 on one side is introduced between the spring clips 14 and latched therein. As a result, the transverse bolt is secured axially against falling out and at the same time secures the pressure medium container 5 on the brake device housing 2. FIG. 3 serves to clarify the state of affairs outlined above using the example of a further embodiment.

In the event of a crash, strong acceleration forces Ff, Fq act on the center of gravity M of the pressure medium container 5. Such acceleration forces can be caused both by the mass of the pressure medium container 5 together with add-on parts and pressure medium itself, and by external objects that act on the pressure medium container 5. Particularly in the case of a frontal impact or a side impact, the corresponding acceleration forces Ff, Fq can turn out to be so high that the container housing 8 collapses. A loss of pressure medium would be unavoidable in such a case.

In order to prevent this, the container housing 8 may be separated from the brake device housing 2 before the acceleration forces acting thereon reach values at which the integrity of the container housing 8 is no longer maintained. The amount of such a limit value of the acceleration forces can be determined structurally when designing the pressure medium container and is dependent on the respective design of the pressure container 5. For this purpose, the two fastening tabs 9, 9′ are deliberately in the form of predetermined breaking points of the combined brake device housing and pressure medium container. The fastening tabs 9, 9′ are designed such that, under a defined breaking load, they tear in a portion which does not entail any damage to the outer wall 22 of the container housing 8. This is effected structurally, for example by a deliberate design of the material thickness or of the connecting point to the container housing 8 or at least a separate notch 23.

At the same time, the fastening tabs 9, 9′ should not be designed to be too weak in order that operating loads do not damage them. The pressure medium container 5 experiences the highest operating loads during initial filling at the vehicle manufacturer. Initial filling is usually carried out under pressure or under negative pressure. In this case, a negative pressure is generated in the brake system and the pressure medium is drawn into the brake system via the container. A comparatively high dynamic pressure arises in the comparatively narrow connecting ducts within the connection pieces 6, 6′ in the process, said dynamic pressure acting on each fastening tab 9, 9′ with a tensile force Fz. This tensile force Fz can be calculated or determined by calculation and by testing for each pressure medium container design.

Therefore, the breaking load which results in tearing of the fastening tabs 9, 9′ always needs to be greater than the greatest force Fz that acts during filling under pressure, multiplied by a defined safety factor. It is recommended to provide a safety factor of at least 50%.

FIG. 3 shows a detail view of another embodiment of the brake device 1 and serves to clarify the above-described latching process of the transverse bolt 11. The depiction reveals four spring clips 14 distributed regularly around the circumference and a hemispherical thickening 15 at one end of the transverse bolt 11. When the transverse bolt is introduced into the opening provided, the spring clips 14 are initially expanded elastically radially outwardly by the thickening 15 and then subsequently snap back and thus retain the thickening in a force- and form-fitting manner in an axial direction.

FIG. 4 shows a three-dimensional view of an embodiment of the brake device according to FIG. 3 with a brake device housing 2 in the form of a hydraulic block. A pressure medium container 5 attached frontally to the brake device housing 2 so as be opposite the actuating member 19 is clearly apparent, as are the drive unit 18 and electronic control unit 16 arranged laterally opposite one another on the same brake device housing 2.

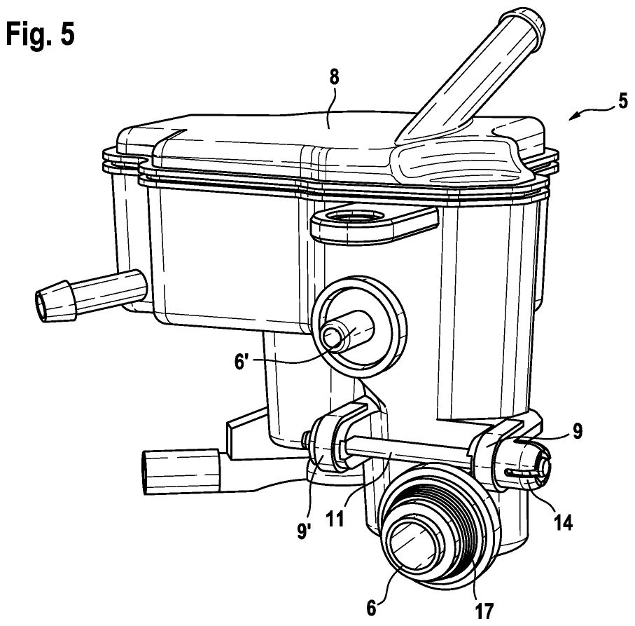

FIG. 5 illustrates the pressure medium container 5 according to FIG. 4 separately in another three-dimensional view. The two connection pieces 6 and 6′ are apparent, which are formed so as to be spaced apart from one another both in a vertical and in a horizontal direction and each have different diameters. The sealing element 17 is arranged on the first connection piece 6. This is not illustrated on the connection piece 6′. Between the two fastening tabs 9, 9′, the container housing 8 has a planar surface portion, which is plane-parallel to the likewise largely planar front side of the cuboid brake device housing 2.

1-11. (canceled)

12. A brake device for a hydraulic motor vehicle brake system comprising:
at least one brake device housing having a front side oriented substantially in the direction of travel after being mounted in the vehicle and a rear side oriented counter to the direction of travel;
a container housing;
at least one pressure medium container arranged on the brake device housing;
at least one first connection piece for the at least one pressure medium container which supplies the brake device with a hydraulic pressure medium; and
wherein the container is oriented one of parallel and at an acute angle to the direction of travel and is plugged in a receiving seat formed in the brake device housing.

13. The brake device as claimed in claim 12, wherein the pressure medium container is arranged on the front side of the brake device housing and fastened thereto.

14. The brake device as claimed in claim 13, wherein the pressure medium container has at least two fastening tabs for fastening to the brake device housing.

15. The brake device as claimed in claim 14, wherein the fastening tabs extend substantially in the direction of travel and are spaced apart from one another transversely to the direction of trave.

16. The brake device as claimed in claim 14, wherein each fastening tab is one of connected to the container housing and integrally formed on the container housing by a first end and has a fastening eye at another end.

17. The brake device as claimed in claim 14, wherein the fastening tabs are offset in the direction of travel with respect to a center of gravity of the pressure medium container.

18. The brake device as claimed in claim 16, wherein the pressure medium container is secured to the brake device housing by a transverse bolt which extends through an aperture in the brake device housing and through the fastening eyes in the at least two fastening tabs.

19. The brake device as claimed in claim 18, wherein the pressure medium container is fixed at least in an axial direction via a latching connection to at least one fastening eye.

20. The brake device as claimed in claim 19, wherein the latching connection comprises a plurality of spring clips which are arranged around the fastening eye on at least one fastening tab and engage radially around a terminal thickening of the transverse bolt.

21. The brake device as claimed in claim 14, wherein the at least two fastening tabs have a predetermined breaking point.

22. The brake device as claimed in claim 21, wherein the breaking point is at least one point under a defined breaking load.

23. The brake device as claimed in claim 21, wherein the breaking load used for a structural design of the fastening tab is higher than a tensile force acting on the fastening tab when the pressure medium container is filled under pressure and lower than a smallest possible force that is necessary for a loss of integrity of the container housing due to acceleration forces acting on the container housing from at least one of the inside and outside.

24. The brake device as claimed in claim 14, wherein the pressure medium container has at least one second connection piece, which is oriented parallel to the first connection piece and is spaced apart therefrom in a vertical direction, and the fastening tabs are arranged in the vertical direction in a region between the first and the second connection piece.

25. The brake device as claimed in claim 12, wherein a hydraulically tight membrane is arranged in the container housing at least partially on an outer wall of the container housing.

26. The brake device as claimed in claim 25, wherein the membrane lines the container housing almost entirely.

27. The brake device as claimed in claim 12, wherein the brake device is mechanically actuable by a driver via an actuating member which is arranged on the rear side of the brake device housing.

28. The brake device as claimed in claim 12, further comprising:
an electromotive drive unit to actuate the brake device; and
an electronic control unit to control the drive unit, wherein the drive unit and the control unit are fastened to the brake device housing on opposite sides.
